(19) United States
(12) Patent Application Publication
(10) Pub. No.: US 2022/0281124 A1
(43) Pub. Date: Sep. 8, 2022

(54) BRAKE SYSTEM FOR ARTICULATED MECHANISM

(71) Applicant: KINOVA INC., Boisbriand (CA)

(72) Inventor: Dominic GOULET, Laval (CA)

(21) Appl. No.: 17/682,074

(22) Filed: Feb. 28, 2022

Related U.S. Application Data
(60) Provisional application No. 63/155,468, filed on Mar. 2, 2021.

(51) Int. Cl. B25J 19/00; F16D 55/38; F16D 65/18; B25J 9/12

(52) U.S. Cl. CPC B25J 19/0004; F16D 55/38; F16D 65/18; B25J 9/126; F16D 2121/22

(57) ABSTRACT

A motorized joint unit of a mechanism has a rotor assembly and a stator assembly operatively assembled and configured for being secured to respective links of the mechanism, the rotor assembly and the stator assembly respectively including a rotor and a stator concurrently operable to cause a rotation of a rotor of the rotor assembly relative to a stator of the stator assembly about a rotational axis, the rotor assembly including a shaft. A brake assembly has a friction clutch assembly including a spoke disk having at least one radial projection. A brake actuator has a plunger displaceable into a path of movement of the radial projection to cause a braking force to be applied by the friction clutch assembly to the shaft when contact is made between the radial projection and the plunger. The brake assembly is connected to the motorized joint unit for the braking force to brake a rotation between the rotor assembly and the stator assembly.

### CROSS-REFERENCE TO RELATED APPLICATION

The present application claims the priority of U.S. Patent Application No. 63/155,468, filed on Mar. 2, 2021, and incorporated by reference.

### TECHNICAL FIELD

The present application relates to robot arms or like articulated mechanisms and to brake systems therefor.

### BACKGROUND OF THE ART

Robotic arms are increasingly used in a number of different applications, from manufacturing, to servicing, and assistive robotics, among numerous possibilities. Serial robot arms are convenient in that they cover wide working volumes. To ensure their precise control, serial robot arms are provided with mechanical brake modules so as to block robot links in desired orientations relative to one another.

Robot arms, such as serial mechanisms, may be provided with secondary brake systems. Such secondary brake systems may be employed in particular circumstances, such as in power outages or control system failures, among possibilities. Indeed, the serial mechanisms are cantilevered in design, and hence may be affected by gravity should their primary brake systems stop being operational. Moreover, serial robot arms may be used to carry payloads. In the event of a primary brake system outage, the payloads may further impact the capacity of a serial robot arm to maintain its position.

### SUMMARY

It is an aim of the present disclosure to provide a robot arm that addresses issues related to the prior art.

Therefore, in accordance with an aspect of the present disclosure, there is provided a motorized joint unit of a mechanism, comprising: a rotor assembly and a stator assembly operatively assembled and configured for being secured to respective links of the mechanism, the rotor assembly and the stator assembly respectively including a rotor and a stator concurrently operable to cause a rotation of a rotor of the rotor assembly relative to a stator of the stator assembly about a rotational axis, the rotor assembly including a shaft; and a brake assembly having a friction clutch assembly including a spoke disk having at least one radial projection, and a brake actuator having a plunger displaceable into a path of movement of the radial projection to cause a braking force to be applied by the friction clutch assembly to the shaft when contact is made between the radial projection and the plunger; wherein the brake assembly is connected to the motorized joint unit for the braking force to brake a rotation between the rotor assembly and the stator assembly.

Further in accordance with the aspect, for example, the friction clutch assembly is connected to the rotor assembly.

Still further in accordance with the aspect, for example, the friction clutch assembly is a coupling portion of the shaft of the rotor assembly.

Still further in accordance with the aspect, for example, the coupling portion has a cylindrical surface, the friction clutch assembly being on the cylindrical surface.

Still further in accordance with the aspect, for example, an annular channel is defined in the cylindrical surface, the friction clutch assembly being held on the coupling portion by a circlip received in the annular channel.

Still further in accordance with the aspect, for example, at least one axial channel is defined in the cylindrical surface, tabs of rings of the friction clutch assembly being received in the axial channel to rotate with the shaft.

Still further in accordance with the aspect, for example, the friction clutch assembly includes a wave spring.

Still further in accordance with the aspect, for example, the friction clutch assembly includes at least one ring of wet friction material.

Still further in accordance with the aspect, for example, the friction clutch assembly includes at least one ring of dustless material.

Still further in accordance with the aspect, for example, the spoke disk includes a plastic shim radially inward thereof for interfacing with the shaft.

Still further in accordance with the aspect, for example, the brake actuator is secured to the stator assembly, and is positioned in an annular volume that is radially outward of a motor between the rotor assembly and the stator assembly.

Still further in accordance with the aspect, for example, the brake actuator has a housing, the plunger forming a sliding joint with the housing.

Still further in accordance with the aspect, for example, the plunger is displaceable between a blocking position in which the plunger is in the path of movement of the radial projection, and a disarmed position in which the plunger is away from the path of movement.

Still further in accordance with the aspect, for example, a displacement of the plunger between the blocking position and the disarmed position is of at least 6 mm.

Still further in accordance with the aspect, for example, the displacement is in a direction that is substantially parallel to an axis of rotation of the rotor assembly.

Still further in accordance with the aspect, for example, a biasing member biases the plunger to the blocking position and an actuator forces the plunger to the disarmed position against the action of the biasing member.

Still further in accordance with the aspect, for example, the biasing member is a coil spring in the housing.

Still further in accordance with the aspect, for example, the actuator is a solenoid coil actuatable to create a magnetic field pushing the plunger away.

Still further in accordance with the aspect, for example, the housing is arc shaped.

Still further in accordance with the aspect, for example, a brake release port is available external to the actuator.

### DESCRIPTION OF THE DRAWINGS

FIG. 1 is a perspective view of an articulated robot arm with a brake system in accordance with an embodiment of the present disclosure;

FIG. 2 is a partially sectioned view of a motorized joint unit featuring the brake system in accordance with the present disclosure;

FIG. 3 is an exploded perspective view of a friction clutch assembly of the brake system of FIG. 2, relative to a shaft of a rotor assembly of the motorized joint unit;

FIG. 4 is a perspective view of the friction clutch assembly of the brake system of FIG. 2;

FIG. 5 is an enlarged section view of the friction clutch assembly of the brake system of FIG. 2;

FIG. 6 is a perspective view of a brake actuator of the brake system of FIG. 2;

FIG. 7 is an exploded view of a brake actuator of the brake system of FIG. 2; and

FIG. 8 is another perspective view of the brake actuator of the brake system of FIG. 2.

### DETAILED DESCRIPTION

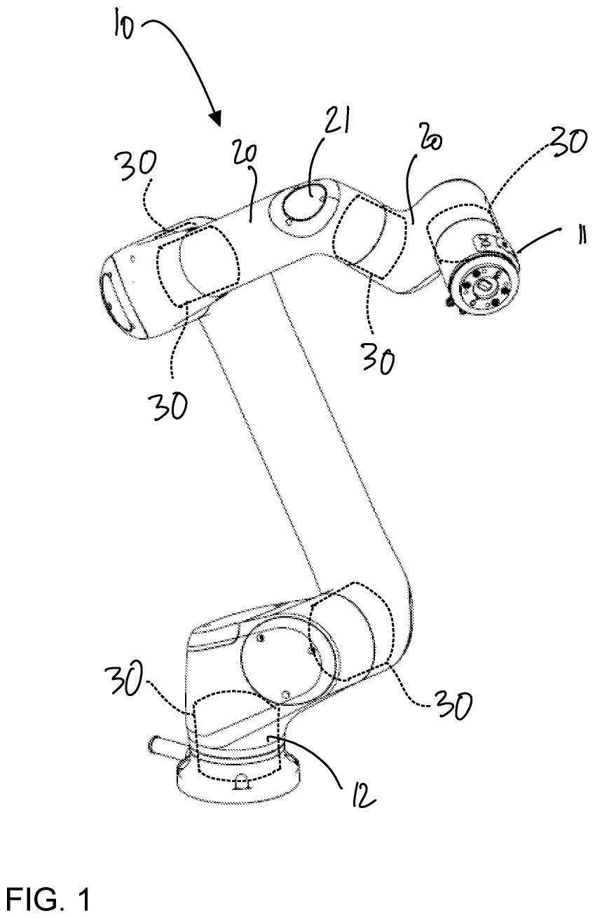

Referring to the drawings and more particularly to FIG. 1, a mechanism such as a robot arm in accordance with the present disclosure is generally shown at 10. Although the internal brake assembly described herein is shown on the robot arm 10, it may be used with other mechanisms, such as articulated mechanisms, or like mechanisms. However, for simplicity, the expression “robot arm” is used throughout, but in a non-limiting manner. The robot arm 10 is a serial articulated robot arm, having an end effector 11 and a base end 12. The end effector 11 is configured to receive any appropriate tool, such as gripping mechanism or gripper, anamorphic hand, and tooling heads such as drills, saws, etc. The end effector secured to the end effector 11 is as a function of the contemplated use. However, the robot arm 10 is shown without any such tool in FIG. 1, a motorized joint unit being shown instead, and ready for supporting a tool. The base end 12 is configured to be connected to any appropriate structure or mechanism. The base end 12 may be rotatably mounted or not to the structure or mechanism. By way of non-exhaustive example, the base end 12 may be mounted to a wheelchair, to a vehicle, to a frame, to a cart, to a robot docking station. Although a serial robot arm is shown the joint arrangement of the robot arm 10 may be found in other types of robots, included parallel manipulators.

The robot arm 10 has a series of links 20 (also known as shells), interconnected by motorized joint units 30 (shown in FIG. 1). In the illustrated embodiment, there are six motorized joint units 30, also known as driver modules, such that the end effector 11 may be displaced in six degrees of freedom (DOF). There may be fewer or more DOFs, FIG. 1 being merely provided as an example. The links 20 define the majority of the outer surface of the robot arm 10. The links 20 also have a structural function in that they form the skeleton of the robot arm 10 (i.e., an outer shell skeleton), by supporting the motorized joint units 30 and tools at the end effector 11, with loads supported by the tools, in addition to supporting the weight of the robot arm 10 itself. Wires and electronic components may be concealed into the links 20, by internal routing. Caps 21 may be provided in the links 20 to provide an access to the motorized joint units 30, for assembling and disassembling the robot arm 10, etc.

The links 20 may be defined by a tubular body, and/or by other structural components. An outer peripheral surface of the tubular bodies forms the majority of the exposed surface of the robot arm 10. The tubular bodies may differ in length, in diametrical dimension, and in shape. For example, as shown in FIG. 1, some of the links 20 may be generally straight or angled, i.e., arranged such that the rotation angles of the motorized joint units 30 at their opposed ends are parallel, perpendicular, or at any other angle. Some links 20 may be longer, etc. Also, although the open ends of the tubular bodies of the links 20 may have the same diameter for all motorized joint units 30 to be the same size, it is contemplated to scale down the motorized joint units 30 from the proximal base end 12 to the distal end effector 11 to reduce the overall weight of the robot arm 10. In such a case, the diameter of the open ends of the links 20 may incrementally reduce toward the distal end. The tubular bodies of the links 20 may consist of any appropriate material, including composites, plastics, metals, or any combination thereof. The tubular bodies may be monolithic pieces, or an assembly of components, and may be molded, extruded, machines, etc.

The motorized joint units 30 interconnect adjacent links 20, in such a way that a rotational degree of actuation is provided between adjacent links 20. According to an embodiment, the motorized joint units 30 may also connect a link to a tool at the end effector 11, or to a base at the base end 12, although other mechanisms may be used at the end effector 11 and at the base end 12. The motorized joint units 30 may also form part of structure of the robot arm 10, as they interconnect adjacent links 20.

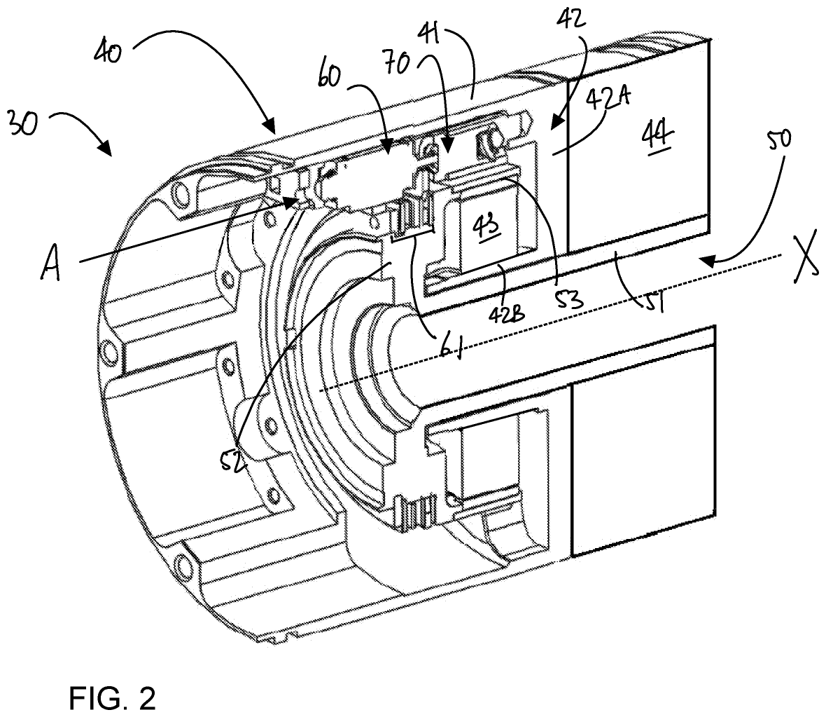

Referring to FIG. 2, one of the motorized joint units 30 is illustrated. The motorized joint unit 30 is shown in a simplified format, as the present disclosure focuses on a brake system at the motorized joint unit 30. The motorized joint unit 30 is of the type having a stator assembly 40, a rotor assembly 50 rotatable relative to the stator assembly 40 along rotational axis X, as a response to actuation from the motorization components inside the motorized joint unit 30. Reverse arrangements of the stator assembly 40 and rotor assembly 50 are possible.

A brake system 60 is located inside the motorized joint unit 30 as described in detail below. The brake system 60 is controlled to block a rotation of the rotor assembly 50 relative to the stator assembly 40, as a secondary brake system, with the motorized joint unit 30 incorporating a primary brake system used during normal operation of the robot arm 10. The primary brake system may be for instance as described in U.S. Pat. No. 10,576,644, incorporated herein by reference. The primary brake system may be actuated during a controlled operation of the robot arm 10, by which the orientation between links 20 is adjusted based on commands from a controller, etc. The primary brake system may for instance block rotation when given orientations between links 20 are achieved.

In contrast, the brake system 60 may be referred to as a secondary brake, a back-up brake, an auxiliary brake, an emergency brake, and is tasked with generally preserving the configuration of the robot arm 10, i.e., immobilizing the robot arm 10, if the primary brake system does not operate. The primary brake system may not operate for various reasons, among which are power outages, control system failures, emergency situations, mechanical failure, as examples among others. In an embodiment, the brake system 60 may be used as a primary brake system.

Other components of the motorized joint unit 30 may include a gear module to reduce the speed of the rotor assembly, and electronic components (sensors, electronic card, processor) to control the operation of the motorized joint unit 30. The present disclosure focuses on the physical arrangement of the brake system 60, whereby other parts of the motorized joint unit 30 not affected by the operation of the brake system 60 may not be detailed.

Referring to FIG. 2, the stator assembly 40 has a casing shell 41. The casing shell 41 forms part of the structure of the stator assembly 40, as it is via the casing shell 41 that the stator assembly 40 is connected to one of the links 20. The casing shell 41 may be secured in any appropriate manner to the tubular body of the link 20. Other arrangements are possible, with the shell 41 integrating or being the link 20. The casing shell 41 has an outer wall 41A, that may be tubular, such that components of the stator assembly 40 may be located inside of the shell 41.

A support 42 is located inside the casing shell 41. The support 42 may also form part of the structure of the stator assembly 40, as components inside the motorized joint unit 30 are supported by the support 42 as described hereinafter. The support 42 may be a drum-like feature, that may include a radial wall 42A inwardly located in the casing shell 41. The radial wall 42A may be substantially radial, i.e., axis X may be normal to its plane, but other arrangements are possible as well. A tubular member 42B may be connected to an inner end of the radial wall 42A. The tubular member 42B may be cylindrical, frusto-conical, etc. In an embodiment, the tubular member 42B is concentric with the outer wall 41A of the casing shell 41, relative to axis X, though this is an option. In another embodiment, the casing shell 41 is monolithic with the support 42 but other attachment arrangements are possible.

An annular receptacle may consequently be defined by an inner surface of the outer wall 41A, the radial wall 42A, and the tubular member 42B. The annular receptacle receives therein the motor 43 that imparts a rotation to the rotor assembly 50, and a part of the brake system 60. The motor 43 is schematically shown, as it may be any appropriate type of actuator, including an electric motor, a pneumatic or hydraulic actuator, etc, and possibly the primary brake system described in U.S. Pat. No. 10,576,644. The motor 43 may for example include a stator core with windings thereon, according to an embodiment. However, for simplicity, the windings and stator core are not shown in the figures. The stator core may be secured to the tubular member 42B. The motor 43 may further include an external rotor for example constituted of a plurality of permanent magnets, supported by a ring. For simplicity, the permanent magnets and the ring are not shown in the figures. The electric motor 43, or like actuator, is operated to provide the desired rotation between adjacent links 20, for example in terms of speed and torque, relative to axis X. The motor 43 or like actuator is configured for reciprocating movement (i.e., clockwise and counterclockwise), and low frequency movements, for some implementations of the robot arm 10. Non exhaustive or limitative rotor/stator kits that may be used include an external rotor motor (e.g., brushless), axial flux or pancake-type motor (brushed, brushless or stepper), internal rotor motors with hollow rotor. The annular receptacle is one contemplated solution to secure the stator of the motor 43 to the structural components of the stator assembly 40. For example, the stator of the motor 43 may be fixed directly to the radial wall 42A.

In an embodiment, a bearing or bearing assembly is generically shown as 44. The bearing assembly 44 is the part of the stator assembly 40 rotatingly supporting the rotor assembly 50, such that the rotor assembly 50 may rotate about the stator assembly 40 as a result of actuation input from the motor 43. For simplicity, the bearing assembly 44 is shown as a box, but may include one or more bearings any suitable type, gears or a gear box (that may also be part of the rotor assembly 50), seals, etc.

The rotor assembly 50 is shown in a simplified configuration, with a shaft 51. The shaft 51 is rotatably connected to the stator assembly 40, for instance by the bearing assembly 44 surrounding the shaft 51 such that the shaft 51 may rotate about axis X. However, the rotor assembly 50 may include other components connected to and rotating with the shaft 51, such as another casing shell having an outer shape similar to that of the casing shell 41 of the stator assembly 40. Hence, the connection of the rotor assembly 50 to the tubular body of the link 20 is not described, as the connection of the casing shell 41 to a link 20 may be used as a reference. The two casing shells, including 41, are separated by a rotation plane, to which a vector of the rotational axis X is normal.

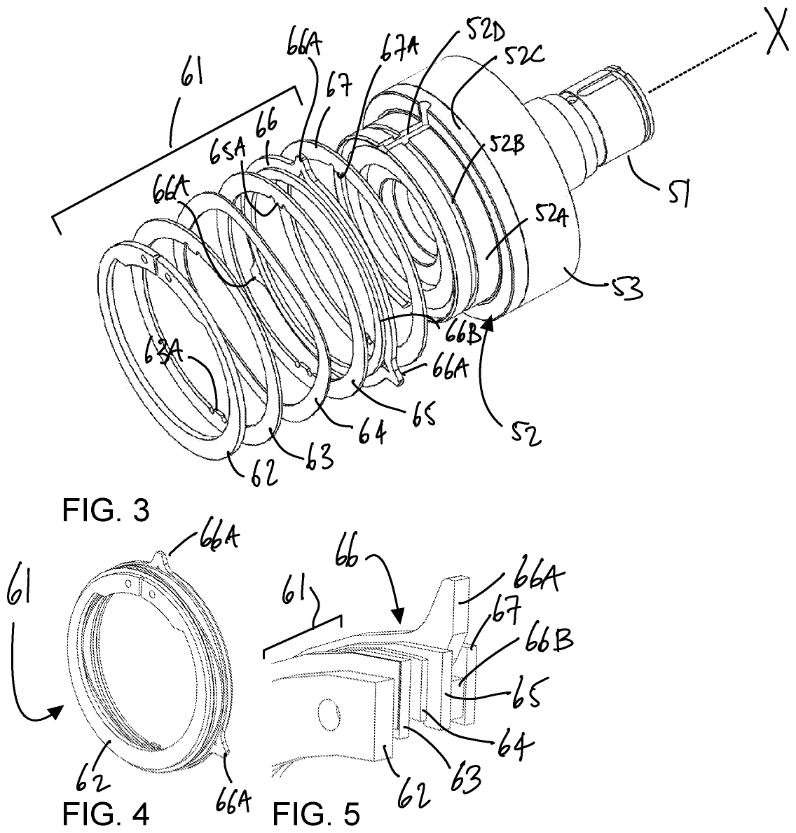

Still referring to FIG. 2, the shaft 51 may have a coupling portion 52 at an end thereof. The coupling portion 52 is the part of the shaft 51 by which the shaft 51 is coupled to the motor 43, so as to receive a drive from the motor 43. As shown in FIG. 3, the coupling portion 52 may have an annular surface 52A and a channel 52B (a.k.a., groove). The annular surface 52A may have a cylindrical geometry, as a possibility (stepped geometry, frusto conical being other possibilities among others), and may be bound by the channel 52B and by a shoulder 52C, though other arrangements are possible. As shown in FIG. 3, one or more keyway 52D or like slot or channel may be defined in the annular surface 52A. The keyway 52D may extend axially, as shown, but other orientations are possible. A pair of diametrically opposed keyways 52D may be present, as shown in FIG. 3. The coupling portion 52 may be used by the brake system 60 to impart braking torque to the shaft 51, as described below. In an embodiment, the coupling portion 52 forms a drum-like component with its tubular member 53, the tubular member 53 being concentric with a main shaft portion of the shaft 51. Likewise, the annular surface 52A may also be concentric with the main shaft portion of the shaft 51. The tubular member 53 may therefore rotate about axis X.

As observed, the tubular member 42A of the stator assembly 40, and the tubular member 53 of the rotor assembly 50 are axially aligned, in that the tubular member 53 is radially outward of the tubular member 42A in an axial segment of the shaft 51. As a result, an annular space is defined between the tubular members 42A and 53, in which the motor 43 or like actuator is received. The rotor ring with permanent magnets of the motor 43 may be secured to the tubular member 53, such that actuation of the motor 43 causes a rotation of the tubular member 53, and thus of the shaft 51.

The above arrangement is provided as an example only, as a reverse arrangement is contemplated as well, for instance with a motor having an inner rotor/outer stator configuration. In such an arrangement, the tubular member 53, or like outer wall or radially inward annular surface, may be part of or integral to the inner shell 41. The various surface features 52A, 52B, 52C and 52D could be directly on the main shaft portion.

Referring to FIGS. 3 and 4, the brake system 60 is shown in greater detail. The brake system 60 has a friction clutch assembly 61 mounted to the shaft 51 and rotating therewith, and a brake actuator 70 that is secured to the stator assembly 40. In an embodiment, the friction clutch assembly 61 is located on the coupling portion 52, but may be located at other positions on the shaft 51, including on the main shaft portion. A reserve arrangement is possible, in which the brake actuator 70 is mounted to the rotor assembly 30, and the friction clutch assembly 61 is mounted on the stator assembly 40.

The friction clutch assembly 61 of the brake system 60 may include a circlip 62, ring 63, spring 64, ring 65, spoke disk 66, and ring 67, sequentially. Fewer or more of these components may be present in the friction clutch assembly 61, or equivalent components. The friction clutch assembly 61 is mounted to the coupling portion 52, and may be sandwiched between the groove 52B and the shoulder 52C, while surrounding the annular surface 52A.

The circlip 62 may consist of a semi-flexible metal ring with open ends. The circlip 62 may be snapped into place, into the groove 52B for example. The circlip 62 may be internal or external. The circlip 62, when in the groove 52B, bounds the annular space with the shoulder 52C between which the other components of the friction clutch assembly 61 will be received. As an alternative to the circlip 62, a threaded ring, a lock ring, etc, could be fixed to the shaft 51.

Rings 63, 65 and 67 may be similar or the same. The rings 63, 65 and 67 may be known as washers, among other possible names. The rings 63, 65 and 67 may each have an inward tab or more (e.g., FIG. 3), also known as a key, respectively shown as 63A, 65A and 67A, the tabs received in the keyway 52D. Therefore, the rings 63, 65 and 67 rotate with the shaft 51, as entrained by the collaboration between the tabs 63A, 65A and 67A and the keyway 52D. The rings 63, 65 and 67 may move axially along the coupling portion 52, but are blocked from rotating because of the collaboration between the tabs 63A, 65A and 67A and the keyway 52D. A single of the rings 63, 65 and 67 could suffice. The rings 63, 65, 67 may be made of materials that may be described as dustless. Such materials may have a slower decrease in braking performance in contrast to other materials, pushing back the need for maintenance. For example, one or more of the rings 63, 65, 67 may be made of bronze, carbon, graphite, aramid fibers. Surface treatment may be provide to increase friction coefficients.

Spring 64 exerts an axial biasing force in the friction clutch assembly 61. The axial biasing force will contribute to the clutching action as described below. In an embodiment, the spring 64 may be a wave spring, sized so as to exert the axial biasing force when the friction clutch assembly 61 is lodged between the groove 52B and the shoulder 52C. As alternatives to a wave spring, a coil spring, an elastomer ring, etc, could be used, to produce the biasing force. In an embodiment, the spring 64 is located between the rings 63 and 65.

Spoke disk 66 is located between the rings 65 and 67. The spoke disk 66 is the part of the friction clutch assembly 61 that interacts with the brake actuator 70. The spoke disk 66 may also be known as a spoke ring, blocking ring, etc. The spoke disk 66 has an annular body, with one or more outward radial projections 66A, also known as spokes. The projections 66A project outwardly from an annular perimeter of the friction clutch assembly 61, so as to catch the brake actuator 70, as will be described below. The projections 66A may be pyramid shaped or triangular, as shown, but other shapes are considered. In an embodiment, the spoke disk 66 including the projections 66A is made of a metallic material. For example, a high hardness material such as steel may be used, and/or a material with dustless properties. A shim 66B, or like inner ring may be located inward of a remainder of the spoke disk 66. The shim 66B may be made of a wear material, such as a plastic, etc. The shim 66B may be in contact with the annular surface 52A and may wear or abrade over time. The material for the shim 66B is selected so as to limit its wear impact on the shaft 51. Materials for the components may be selected to minimize debris from the plunger pin impacts and the clutch friction and wear, for the robot lifecycle, to avoid impacting the functionality of the sensors or the motor itself. The frictional clutch assembly 61 may be adjustable in compression (e.g., spacing, spring 64) to match actuator sizing, torque and inertia.

During use, one of the projections 66A of the spoke disk 66 may come into contact with the brake actuator 70, as explained below. Because of the projection 66A, the spoke disk 66 will be prevented from rotating, and will be fixed relative to the stator assembly 40, as the brake actuator 70 is secured to the stator assembly 40. The spoke disk 66 does not have any direct mechanical interference with the shaft 51, i.e., it can rotate relative to the shaft 51. However, because of frictional forces between the spoke disk 66 and the rings 65 and 67 (or with the shoulder 52C if there is no ring 67), a rotation of the shaft 51 (and rings 65, 67) will be against these frictional forces. With the spring 64 providing suitable biasing force, the frictional forces, proportional to the biasing force, will cause a deceleration of the rotation between the shaft 51 and the stator assembly 40. The frictional forces may even cause a full braking of the rotation of the shaft 51—and rotor assembly 50—relative to the stator assembly 40. By having multiple projections 66A, such as three separated by about 120 degrees, four, separated by 90 degrees, five, etc, the rotation of the rotor assembly 50 possible until contact is made with the stator assembly 40 is limited. In some instances, the friction clutch assembly 61 may accidentally be exposed to oil or grease, as oil or grease may be used as a lubricant for bearings, for a reduction gear box. The robot arm 10 may also be used in processes or applications in which it is exposed to oil, that could penetrate the motorized joint unit 30. Accordingly, some or all of the components of the friction clutch assembly 61, and in particular those involve in the friction braking, may be made of a wet friction material, i.e., WFM, such as woven carbon fiber embedded in a synthetic resin. For example, the spoke disk 66 and the rings 63, 65 and/or 67 may be made of such WFM, as a possibility.

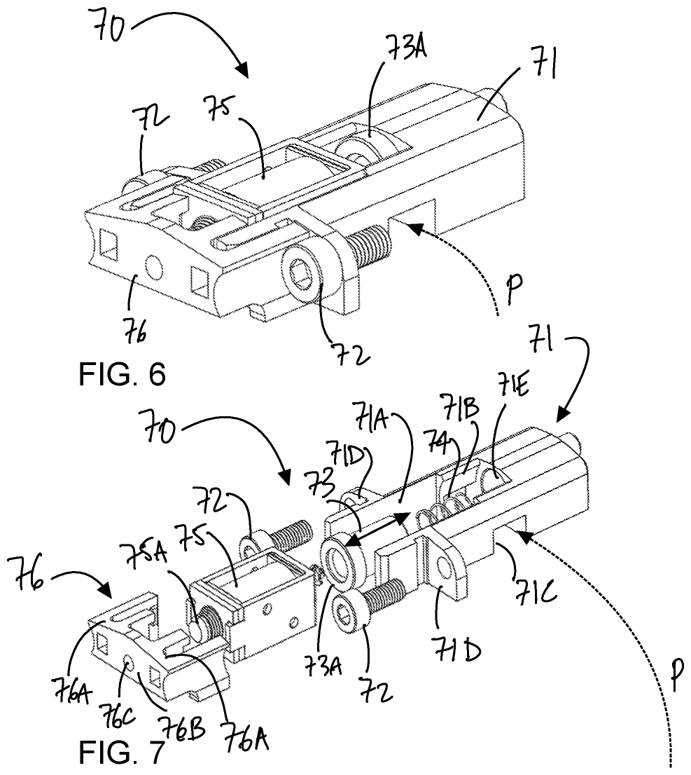

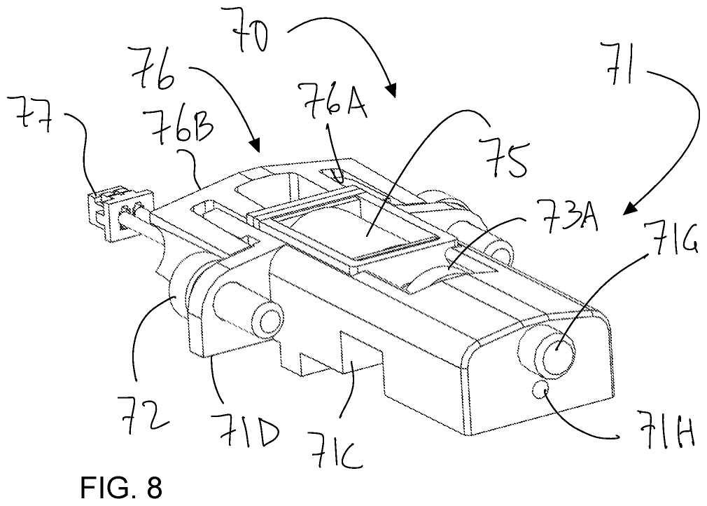

Referring to FIGS. 6 and 7, the brake actuator 70 is shown in greater detail. The brake actuator 70 may be located in an annular space that is radially outward of the motor 43. Stated differently, the brake actuator 70 is located at least partially in an axial segment of the motorized joint unit 30 in which the motor 43 is, the axial segment being delimited by axial planes (to which a vector of the axis X is normal) on opposite sides of the motor 43. The brake actuator 70 has a housing 71 by which it may be connected to the shell 41 of the stator assembly 40. The housing 71 may be made of a rigid material to provide the structural integrity to the brake actuator 70 during braking actions. The housing 71 may define an elongated slot 71A that is open at an end. Joint surfaces 71B may be provided on side surfaces of the slot 71A. The joint surfaces 71B may be cylindrically shaped, i.e., form cylindrical surface segments. Passage(s) 71C may be provided in the walls of the elongated slot 71A, for penetration of the projection 66A of the spoke disk 66 therein. Connection plates 71D may project from the walls of the elongated slot 71A, for the anchoring of the brake actuator 70 to the shell 41 of the stator assembly 40, for instance via fasteners 72 (e.g., bolts, screws, etc). The connection plates 71D are one possible solution to secure the housing 71 to the stator assembly 40. The housing 71 may further include a receptacle 71E, though optional, so long as sliding joint features are present. As shown in FIG. 8, in order for the housing 71 to be anchored to the stator assembly 40, a projection 71G may be present, as one solution among others, received in a corresponding bore in the stator assembly 40. Moreover, there may be more than a single one of the projection 71G. The projection 71G may be a cylindrical extrusion at the end of the housing 71, used to take some of the load during braking, or prevent to limit deformation of the housing 71. Should the housing 71 deform, the contact between the projection 71G and the support 42 will limit deformation of housing 71 and reduce a risk of failure of this part. The reverse arrangement of male-female connector may be used, with a bore in the housing 71, or a flange with fasteners, etc. A vent hole 71H may optionally be present, so as to freely allow movement of plunger 73 without a pressure build-up.

Referring to FIGS. 6 and 8, plunger 73 may be accommodated in the receptacle 71E of the housing 71. Surfaces 71B partly receive the plunger head 73A in operation. The plunger 73 may be known as a pin, an abutment, a stop, etc, among other possible names. The plunger 73 may have a head 73A that is shaped to be complementary to a shape of the joint surfaces 71B, such as the cylindrical shape shown. Consequently, the joint surfaces 71B and the plunger 73 concurrently form a sliding joint, such that the plunger 73 may move in the direction shown in FIG. 7. The head 73A may act a stopper to limit a penetration of the plunger 73 in the receptacle 71E. Other types of joints are contemplated, including a telescopic joint. Due to its function of receiving an impact from the projection of the spoke disk 66 or like ring, the plunger 73 may also be made of a material with high rigidity, such as steel.

A biasing device 74, such as a coil spring, may be provided so as to bias the plunger 73 outwardly, i.e., the left-hand side in FIGS. 6 and 7. The plunger 73 may be aligned with the passages 71C, or block the path P of the projection 66A in some other manner, in a blocking position. However, if a contrary force is applied to the plunger 73, it may move farther into the receptacle 71E—toward the right-hand side in FIGS. 6 and 7, and no longer block the path P, in a disarmed position. The plunger 73 may therefore cause the braking action by the friction clutch assembly 61, as described above. The biasing device 74 is in the receptacle 71E. In an embodiment, a distance of travel between the blocking position and the disarmed position is of at least 6 mm. The displacement of the plunger 73 may be in a direction that is substantially parallel to an axis of rotation of the rotor assembly 40, though this is optional.

In an embodiment, the movement of the plunger 73 toward the right-hand side in FIGS. 6 and 7 is caused by a solenoid coil 75, as one possible actuator that may be used. Other methods of actuation could include linear motors or linear actuators. In an embodiment, when the solenoid coil 75 is activated, it creates a magnetic force the keeps the plunger 73 in the receptacle 71E, against the action of the spring 74. In an embodiment, when the solenoid coil 75 is activated, the magnetic forces react with a pushing pin (included with the solenoid and seen in FIG. 2) that pushes against the plunger 73. Ferromagnetic properties of plunger 73 are not of any usage for this function. The solenoid coil 75 is deactivated when current is shut down, resulting in the plunger 73 moving to the left-hand side in FIGS. 6 and 7, by action of the spring 74, to the blocking position. The solenoid coil 75 may have a detent 75A or equivalent release button, by which it may be manipulated to displace the pushing pin (FIG. 2) and move the plunger 73 away from the blocking positon and to the disarmed position. Hence, the detent 75A could be used to move the plunger 73 to its disarmed position and liberate the path P when the robotic arm 10 is not powered.

A cover 76 may be provided to be clipped onto the housing 71, and capture the solenoid coil 75 therebetween. The cover 76 may have a pair of U-shaped formations 76A that may clip onto ends of the walls defining the elongated slot 71A. The U-shaped formations 76A are an option among others. In an embodiment, the cover 76 snap fits to the housing 71. Tongue and grooves, nails and slots, etc, may be provided for the connection between the cover 76 and the housing 71. Concavities illustrated in the walls of the cover 76 may accommodate the heads of the fasteners 72, and this may further contribute to the securing of the cover 76 to the housing 71 and to the stator assembly 40. A web 76B may be between the U-shaped formations 76A. The web 76B may have a hole 76C to define an access to the detent 75A. A wire and connector 77 may project out of the cover 76, for the connection of the brake actuator 70 to a controller of the robot arm 10.

The brake actuator 70 is positioned in the stator assembly 40 in such a way that the plunger 73 may block the path P of movement of the projection(s) 66A, when the brake actuator 70 actuates the braking. In such circumstances, the plunger 73 blocks the rotation of the spoke disk 66, and hence have the friction clutch assembly 61 apply frictional forces against rotation. Moreover, it is observed in FIG. 6 that the radially outward surfaces of the brake actuator 70 may be arcuate, convex in shape (e.g., trapezoidal, triangular, etc, in cross-section) to allow the brake actuator 70 to use the available space and be in proximity to the inner surface of the shell 41.

In an embodiment, the brake system 60 is used as an emergency brake, for the robot arm 10 to limit rotation of its links 20 in given circumstances. For example, the brake system 60 is activated when there is power outage or when the robot arm 10 is turned off, with the solenoid coil 75 or equivalent is not powered. It is also considered to use the brake system 60 as a primary brake, when the projection(s) 66A are in contact with the plunger 73. In such use, the motor 43 would have to work against the frictional forces to cause a relative rotation between the stator assembly 40 and the rotor assembly 50. In emergency use, the motor 43 will be deactivated (no power) when the brake is activated, i.e., the motor 43 will not work against the frictional forces of the brake system 60 during an emergency stop event.

Referring to FIG. 2, in an embodiment the brake system 60 is located in an annular space between the shell 41 and the coupling portion 52. Access to the brake system 60 may be possible via direction A in order to release the brake manually. The access via hole 76C is provided to allow the user to disengage the brake (i.e. to push on the plunger 73) during maintenance, for example. To get access to this hole 76C, the cap 21 may need to be removed.

The brake system 60 may be usable for “spoke-disc” type solenoid brakes as shown above, but may also be used for purely frictional brakes. In this function, the brake system 60 may be rated as a category 1 stop (wherein the servo gets the arm stationary before engaging the brake). The category 1 stop in the ISO 10218 standard and/or to IEC60204-01 standard, in an embodiment, with the brake system 60 enabling compliance to the standard(s). By having a single brake capable of both these brake methods, costs are reduced.

1. A motorized joint unit of a mechanism, comprising:
a rotor assembly and a stator assembly operatively assembled and configured for being secured to respective links of the mechanism, the rotor assembly and the stator assembly respectively including a rotor and a stator concurrently operable to cause a rotation of a rotor of the rotor assembly relative to a stator of the stator assembly about a rotational axis, the rotor assembly including a shaft; and
a brake assembly having
a friction clutch assembly including a spoke disk having at least one radial projection, and
a brake actuator having a plunger displaceable into a path of movement of the radial projection to cause a braking force to be applied by the friction clutch assembly to the shaft when contact is made between the radial projection and the plunger;
wherein the brake assembly is connected to the motorized joint unit for the braking force to brake a rotation between the rotor assembly and the stator assembly.

2. The motorized joint unit according to claim 1, wherein the friction clutch assembly is connected to the rotor assembly.

3. The motorized joint unit according to claim 2, wherein the friction clutch assembly is a coupling portion of the shaft of the rotor assembly.

4. The motorized joint unit according to claim 3, wherein the coupling portion has a cylindrical surface, the friction clutch assembly being on the cylindrical surface.

5. The motorized joint unit according to claim 4, wherein an annular channel is defined in the cylindrical surface, the friction clutch assembly being held on the coupling portion by a circlip received in the annular channel.

6. The motorized joint unit according to claim 3, wherein at least one axial channel is defined in the cylindrical surface, tabs of rings of the friction clutch assembly being received in the axial channel to rotate with the shaft.

7. The motorized joint unit according to claim 1, wherein the friction clutch assembly includes a wave spring.

8. The motorized joint unit according to claim 1, wherein the friction clutch assembly includes at least one ring of wet friction material.

9. The motorized joint unit according to claim 1, wherein the friction clutch assembly includes at least one ring of dustless material.

10. The motorized joint unit according to claim 1, wherein the spoke disk includes a plastic shim radially inward thereof for interfacing with the shaft.

11. The motorized joint unit according to claim 1, wherein the brake actuator is secured to the stator assembly, and is positioned in an annular volume that is radially outward of a motor between the rotor assembly and the stator assembly.

12. The motorized joint unit according to claim 1, wherein the brake actuator has a housing, the plunger forming a sliding joint with the housing.

13. The motorized joint unit according to claim 12, wherein the plunger is displaceable between a blocking position in which the plunger is in the path of movement of the radial projection, and a disarmed position in which the plunger is away from the path of movement.

14. The motorized joint unit according to claim 13, wherein a displacement of the plunger between the blocking position and the disarmed position is of at least 6 mm.

15. The motorized joint unit according to claim 14, wherein the displacement is in a direction that is substantially parallel to an axis of rotation of the rotor assembly.

16. The motorized joint unit according to claim 13, wherein a biasing member biases the plunger to the blocking position and an actuator forces the plunger to the disarmed position against the action of the biasing member.

17. The motorized joint unit according to claim 16, wherein the biasing member is a coil spring in the housing.

18. The motorized joint unit according to claim 16, wherein the actuator is a solenoid coil actuatable to create a magnetic field pushing the plunger away.

19. The motorized joint unit according to claim 12, wherein the housing is arc shaped.

20. The motorized joint unit according to claim 1, wherein a brake release port is available external to the actuator.
